(19) United States
(12) Patent Application Publication
(10) Pub. No.: US 2017/0277398 A1
(43) Pub. Date: Sep. 28, 2017

(54) IMAGE DISPLAY DEVICE

(71) Applicant: TOYOTA JIDOSHA KABUSHIKI KAISHA, Toyota-shi (JP)

(72) Inventors: Masahisa ISHIBASHI, Nisshin-shi (JP); Yasutaka YOSHIMURA, Miyoshi-shi (JP)

(73) Assignee: TOYOTA JIDOSHA KABUSHIKI KAISHA, Toyota-shi (JP)

(21) Appl. No.: 15/418,239

(22) Filed: Jan. 27, 2017

(30) Foreign Application Priority Data
Mar. 22, 2016 (JP) 2016-057114

(51) Int. Cl. G06F 3/0481; G06F 3/0482; G06F 3/0488

(52) U.S. Cl. CPC G06F 3/04817; G06F 3/04883; G06F 3/0482

(57) ABSTRACT

An image display device includes: an image display means; a user operation input means provided in a display area of the image display means; and a display control means configured to control display by the image display means. The display control means: generates a menu screen that shows a plurality of main icons indicating a plurality of function types and one or more sub-icons indicating a function belonging to one of the plurality of function types; and displays one of the plurality of main icons in the menu screen in a larger size than the other main icons, and displays, around the main icon displayed in the larger size, the one or more sub-icons corresponding to some of functions belonging to the function type indicated by the main icon, an upper limit of a number of sub-icons being defined by a predetermined number.

### BACKGROUND

1. Technical Field

The present disclosure relates to image display devices and, more particularly, to image display devices for vehicles.

2. Description of Related Art

Recently, vehicles are often provided with an image display device for displaying maps etc. according to a car navigation system. A user operation input means using a touch-sensitive panel is provided on a display screen. A user operation input is provided by manipulating an icon, etc. displayed on the screen using a finger. For example, a tap on an icon for displaying a menu shows a top menu screen in which a list of plurality of menu icons for destination, air conditioner, audio, information presentation, etc. are displayed. A tap on a desired menu icon in the top menu screen shows a sub-menu screen for selecting a detailed content. Selection of further menus shows screens for calling in various functions such as destination setting, sound volume setting, and vehicle information presentation.

Functions called in via an image display device of a vehicle are diversified and the number of types of functions selectable via a menu screen is on the increase. Meanwhile, the number of menu icons that can be displayed at a time in a restricted display area is limited. An increase in the number of functions should be addressed by increasing the number of layers in the hierarchy of menu screens or by providing a page feed function. Consequently, the user must provide multiple user inputs every time to reach a screen for calling in a desired function. A negative impact from diversification of functions is complicated user operations for selecting functions.

Attempts to display as many menu icons as possible in a restricted display area in order to reduce the number of layers in the hierarchy of menu screens or the number of pages result in smaller sizes of icons displayed and a flat mode of presentation in which it is difficult to distinguish one item from another. This makes it difficult to determine which icon corresponds to which menu at a glance and results in reduced convenience that makes it impossible to select a desired function quickly.

### SUMMARY

The present invention addresses this background and a general purpose thereof is to provide a technology capable of displaying menu screens in a manner that operability and viewability are enhanced.

The image display device according to one embodiment comprises: an image display means; a user operation input means provided in a display area of the image display means; and a display control means configured to control display by the image display means based on a user operation input in the user operation input means. The display control means is configured to: generate a menu screen that shows a plurality of main icons indicating a plurality of function types and one or more sub-icons indicating a function belonging to one of the plurality of function types; and display one of the plurality of main icons in the menu screen in a larger size than the other main icons, and display, around the main icon displayed in the larger size, the one or more sub-icons corresponding to some of functions belonging to the function type indicated by the main icon, an upper limit of a number of sub-icons being defined by a predetermined number.

According to this embodiment, sub-icons corresponding to some functions are displayed around the main icon displayed in a large size. Therefore, the user can select functions (e.g., frequently used functions) immediately. As a result, the user can select and run some functions in the top menu screen in which the main icons are displayed without opening a sub-menu screen for selecting a particular function. Since the sub-icons are arranged around the main icon displayed in a large, the main icon displayed in noticeable fashion and the sub-icons around catch the eyes of the user naturally so that the viewability of the sub-icons is enhanced and a search for a target icon is facilitated. Accordingly, the embodiment provides a user-friendly menu screen with superior operability and viewability.

The display control means may be configured to display the one or more sub-icons corresponding to relatively frequently used functions around the main icon displayed in the larger size.

The display control means may be configured to display the one or more sub-icons corresponding to functions pre-registered by a user around the main icon displayed in the larger size.

The display control means may be configured to display the plurality of main icons arranged on an upwardly convex arc, and switch the main icon displayed in the larger size to another main icon in response to a swipe operation along the arc provided via the user operation input means while the menu screen is being displayed.

The display control means may be configured to arrange the main icon displayed in the larger size at a center of the display area and arrange the other main icons on the left or right of the display area.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a functional block diagram showing the configuration of an image display device according to an embodiment;

FIG. 2 shows an example of displaying a top menu screen;

FIG. 3 shows an example of displaying a top menu screen;

FIG. 4 shows an example of displaying a sub-menu screen; and

FIG. 5 shows an example of displaying a top menu screen according to a comparative example.

### DETAILED DESCRIPTION

Various embodiments will now be described by reference to the drawings. The embodiments are illustrative and are not intended to be limiting.

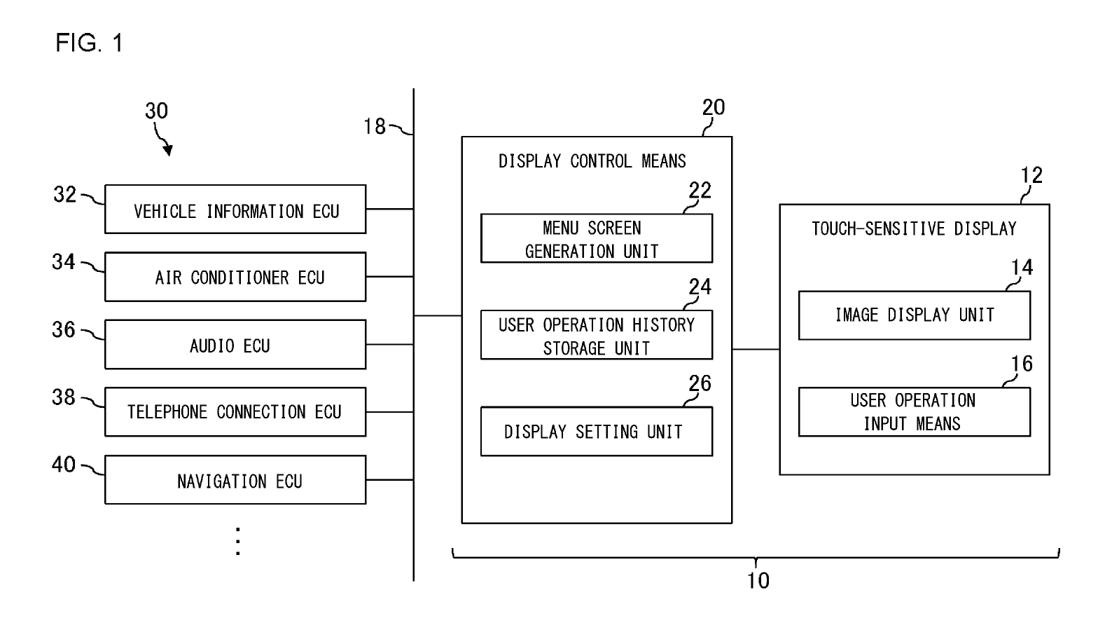

FIG. 1 is a functional block diagram showing the configuration of an image display device 10 according to an embodiment. The functional blocks depicted are implemented in hardware such as devices or mechanical components such as a CPU or a memory of a computer, and in software such as a computer program. FIG. 1 depicts functional blocks implemented by the cooperation of these elements. Therefore, it will be understood by those skilled in the art that the functional blocks may be implemented in a variety of manners by a combination of hardware and software.

The image display device 10 includes a touch-sensitive display 12 and a display control means 20. The image display device 10 functions as a so-called Human Machine Interface (HMI). The touch-sensitive display 12 includes an image display means 14 and a user operation input means 16. The image display means 14 is a display device such as a liquid crystal display and is attached to the position of a center console or dashboard of a vehicle. The user operation input means 16 is a sensor of a touch-sensitive panel type and is provided in a display area of the image display means 14.

The image control means 20 is connected to the touch-sensitive display 12 and an on-vehicle network 18. The display control means 20 is connected via the on-vehicle network 18 to various Electronic Control Units (ECU) 30 mounted on the vehicle. In this embodiment, the ECUs 30 are exemplified by an on-vehicle information ECU 32, an air conditioner ECU 34, an audio ECU 36, a telephone connection ECU 38, and a navigation ECU 40. However, the type of ECU connected to the display control means 20 is not limited to the above examples. ECUs of functions or types different from those illustrated may be connected. Some of the ECUs illustrated may not be connected to the display control means 20. The display control means 20 may be connected directly to the ECUs 30 without using the on-vehicle network 18.

The display control means 20 generates a user operation screen to provide an input operation via the user operation input means 16 and causes the image display means 14 to display the user operation screen. The display control means 20 generates a control signal based on the content of user operation input via the user operation input means 16 and transmits the control signal to the ECUs 30 via the on-vehicle network 18. The display control means 20 generates a display screen displayed on the image display means 14 based on signals received from the ECUs 30. For example, the display control means 20 generates a vehicle information display screen based on the vehicle information acquired from the vehicle information ECU 32 and generates a navigation screen based on map information acquired from the navigation ECU 40.

The display control means 20 includes a menu screen generation unit 22, a user operation history storage unit 24, and a menu display setting unit 26. The menu screen generation unit 22 generates menu screens in which icons to select a function by an input operation via the user operation input means 16 are arranged. The menu screens are hierarchized. A top menu screen to select a function type such as “destination”, “information”, “telephone”, and “applications” and a sub menu screen to select a specific function after selecting a function type are prepared.

The user operation history storage unit 24 stores a history of user operation inputs. The user operation history storage unit 24 includes a list information listing functions selectable via the user operation input means 16 and stores information such as the number of times of use, frequency of use, date and time of use, etc. of the functions. For example, the number of times of use is an accumulated value of the number of times of use over a total period of time elapsed since the history information stored by the user operation history storage unit 24 is reset. Every time a function is selected, the value indicating the number of times of use is incremented. The frequency of use is an accumulated value of the number of times that a given function is used over a predetermined period of time (e.g., for the past one month, three months, half year, one year). The user operation history storage unit 24 identifies a function frequently by the user by storing a user operation history.

The menu display setting unit 26 stores parameters for determining a display mode of a display screen generated by the menu screen generation unit 22. The menu display setting unit 26 stores parameters for determining the sequence and priority of displaying icons in a menu screen. For example, the menu display setting unit 26 defines those of the icons corresponding to a given function type that are displayed in preference to the other icons. The menu display setting unit 26 determines icons displayed in preference in accordance with the number of times of use and history of use stored in the user operation history storage unit 24. For example, the menu display setting unit 26 defines frequently used icons to be displayed in preference to the other icons. The menu display setting unit 26 may predefine icons displayed in preference according to a user's input operation or may accept and store registration of favorites. The menu screen generation unit 22 generates a menu screen in accordance with the setting in the menu display setting unit 26.

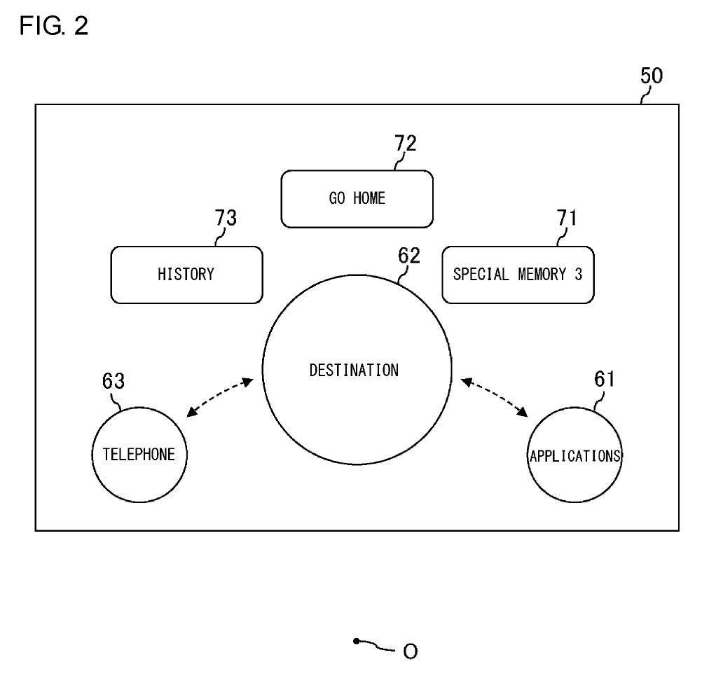

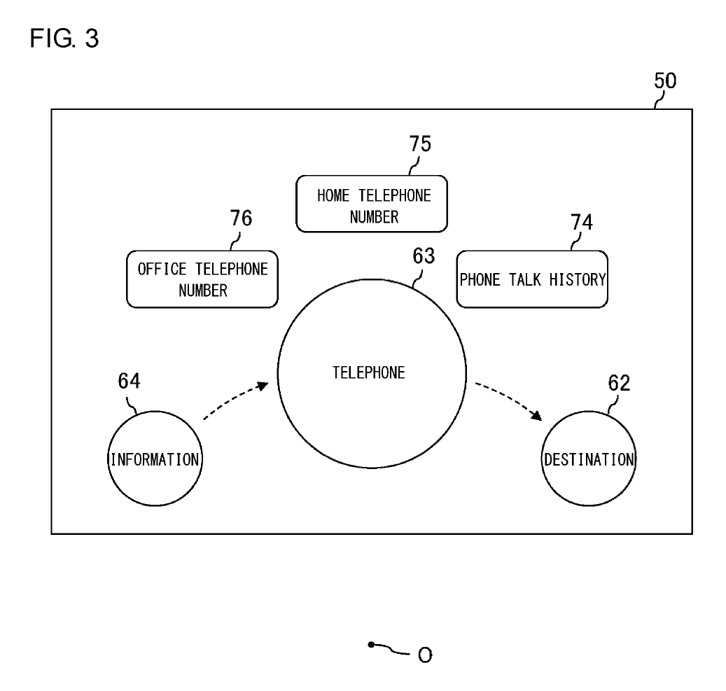

A description will now be given of an example of displaying a menu screen. FIGS. 2 and 3 show examples of displaying a top menu screen 50. A plurality of main icons 61, 62, 63 and one or more sub-icons 71, 72, 73 are arranged in the top menu screen 50 of FIG. 2. The plurality of main icons 61-63 are arranged on an arc around a point O virtually defined toward the bottom of the display area. In other words, the icons are arranged on an upwardly convex arc with reference to the vertical direction of the screen. The main icon 62 displayed at the center is larger in size than the other main icons 61, 63 arranged to the left and right and is displayed in a mode more noticeable than the other main icons 61, 63. The main icon 62 displayed in a larger size may be displayed in a color distinctively different from those of the other main icons 61, 63 or sub-icons 71-73. The one or more sub-icons 71-73 are arranged around the main icon 62 displayed in a larger size and are arranged to surround the main icon 62. The one or more sub-icons 71-73 may be arranged at a distance from the arc on which the plurality of main icons 61-63 are arranged or arranged only in an area above the arc, as illustrated.

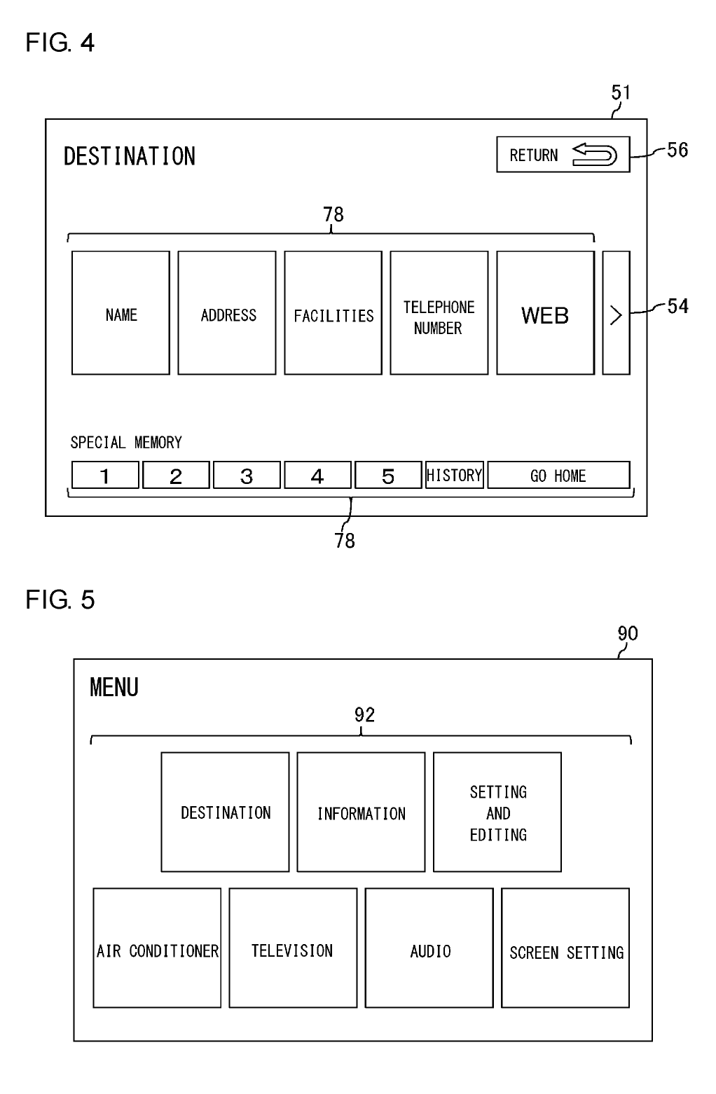

The plurality of main icons 61-63 indicate function types and indicate large categories of functions selectable via the user operation input means 16. In this embodiment, “destination”, “information”, “telephone”, “applications” are provided as function types. Main icons indicating the respective function types are displayed in the top menu screen 50. In the top menu screen 50 shown in FIG. 2, the three main icons 61-63 for “applications”, “destination”, “telephone” are displayed, and the menu icon for “information” is not displayed. A tap on one of the plurality of main icons 61-63 shows a sub-menu screen for a function type corresponding to the main icon tapped. When the main icon 62 for “destination” is tapped, for example, a sub-menu screen (FIG. 4 described later) for allowing a selection of a function for setting a destination of the navigation system is displayed.

The plurality of main icons 61-63 are configured to be movable along the arc around the virtually defined point O. For example, the display positions of the main icons are switched by swiping left or right along the arc, with the finger in contact with the main icon 62 at the center. By swiping right, the main icons will be displaced one position to the right, as shown in FIG. 3. More specifically, the main icon 62 for “destination” is arranged to the right, the main icon 63 for “telephone” is arranged at the center, and the main icon 64 for “information” is arranged to the left. The main icon 63 for “telephone” arranged at the center is displayed in a larger size than the other main icons 62, 64. The main icon 62 for “destination” previously arranged at the center is displayed in a smaller size and arranged to the right.

The one or more sub-icons 71-73 indicate functions selectable via the user operation input means 16. In the top menu screen 50, only those sub-icons indicating functions belonging to the function type of the main icon 62 displayed at the center of the screen in a large size are shown. Sub-icons indicating functions belonging to the other function types are not displayed. In the exemplary screen shown in FIG. 2, the main icon 62 for “destination” is displayed in a large size. Therefore, three sub-icons 71-73 for “special memory 3”, “go home”, “history”, functions related to setting of a destination, are displayed. Meanwhile, in the exemplary screen of FIG. 3, the main icon 63 for “telephone” is displayed in a large size. Therefore, three sub-icons 74-76 for “phone talk history”, “home telephone number”, “office telephone number”, functions related to the telephone, are displayed. If the main icon 61 for “applications” is displayed at the center in a large size, sub-icons corresponding to air conditioner setting function, audio/television/video playback function, and web information display function are displayed. If the main icon 64 for “information” is displayed at the center in a large size, sub-icons corresponding to functions for displaying the distance of travel, fuel cost of the vehicle, etc. are displayed. In the case of a hybrid vehicle, sub-icons corresponding to functions for displaying information on rechargeable batteries, etc. are displayed.

The upper limit of the number of one or more sub-icons 71-73 is defined by the setting in the menu display setting unit 26. The number of sub-icons displayed in the top menu screen 50 is limited. Of a plurality of functions belonging to a given function type, only those functions frequently used by the user or functions registered by the user as favorites are displayed. In the illustrated example, the number of sub-icons displayed in the top menu screen 50 is 3. Alternatively, the number of sub-icons may be 1 or 2, 4 or 5, or 6 or more. It is preferable that a certain limited number of (e.g., 3-5 or fewer) sub-icons be displayed so that the viewability of sub-icons is not impaired. The number of sub-icons displayed in the top menu screen 50 may be fixed or variable depending on the user setting. If the number of sub-icons displayed can be changed according to the user setting, the number is stored in the menu display setting unit 26.

FIG. 4 shows an example of displaying a sub-menu screen 51. The figure shows the sub-menu screen 51 displayed after “destination” is selected as a function type. A plurality of sub-icons 78 for selecting specific functions are displayed in the sub-menu screen 51. The plurality of sub-icons 78 indicate different methods for setting a destination in the navigation system. More specifically, sub-icons including an icon “name” for setting the name of a destination using the order of the Japanese syllabary, an icon “address” for setting a destination from a list of addresses, an icon “facilities” for setting a destination from a list of genres of facilities, an icon “telephone number” for searching for and setting a destination using a telephone number, and an icon “WEB” for setting a destination by a Web search. Sub-icons 78 including icons for special memories “1”-“5” for setting a spot pre-registered in a special memory as a destination, an icon “history” for setting a destination from a list of past history, an icon “go home” for setting a pre-registered address for home as a destination, etc. are also prepared.

There may be other functions belonging to the function type “destination”. For examples, those functions include “memorized spot” for setting a destination from a list of spots registered in the memory, “genre” for designating a genre of facilities and selecting a facility near the current spot or the destination from a list, “map code” for setting a destination by entering a map code, etc. Sub-icons for selecting these functions cannot be accommodated in the sub-menu screen 51 of FIG. 4 and so are displayed in separate pages. A tap on a page feed icon 54 displayed in the sub-menu screen 51 switches pages in the sub-menu screen 51 and displays a sub-menu screen in which sub-icons “memorized spot”, “genre”, “map code”, etc. are arranged. A tap on a return icon 56 switches to the top menu screen displayed prior to the transition to the sub-menu screen 51 of FIG. 4 or another sub-menu screen.

A description will now be given of the advantage of the embodiment by referring to a comparative example. FIG. 5 shows a top menu screen 90 according to a comparative example. In the top menu screen 90 according to the comparative example, only a plurality of main icons 92 indicating respective function types are shown and no sub-icons are shown. In the case of the top menu screen 90 according to the comparative example, a function is selected by selecting a main icon 92 indicating a function type and then tapping a sub-icon in a sub-menu screen subsequently displayed. If the sub-menu screens are hierarchized, the user will have to select a specific function after opening a menu screen lower in the hierarchy than the sub-menu screen. This requires at least two user operations to run a specific function and creates a need to find an icon corresponding to a function desired to be used every time menu screens are switched. In the top menu screen 90 according to the comparative example, the plurality of main icons 92 are displayed in similar sizes and display modes and in an orderly manner. This makes it difficult to distinguish between icons and requires a lot of time to find a main icon for a target function.

In the top menu screen 50 according to the embodiment, on the other hand, sub-icons 71-73 that are frequently used are displayed around the main icon 62 arranged at the center in a large size. If a target function is frequently used, it can be run by performing a single user operation in the top menu screen 50. Since the main icon 62 is displayed at the center of the screen in a large size, the main icon 62 at the center naturally catches the eyes of a user glancing at the top menu screen 50 and the sub-icons 71-73 arranged around the main icon 62 naturally come into the view of the user. Therefore, if a sub-icon corresponding to a function desired to be used is displayed, the user can identify and select the sub-icon immediately. Accordingly, the user operation for selecting a function that is often used is simplified and user convenience is enhanced.

Even if the user wishes to select a function that is used less frequently, the viewability of the main icon 62 displayed at the center in a large size is better than the main icons of the top menu screen 90 according to the comparative example. Assuming that the main icon 62 displayed in a large size is different from that of a target function type, the user can immediately recognize that it is not a target main icon and so can switch screens to display another function type at the center by moving the main icon 62 to the left or right. The display positions of the sub-icons remain substantially unchanged by switching function types of the main icon displayed in a large size. Therefore, the user can easily see whether sub-icons desired to be used are displayed without changing the position of the eyes. This saves the effort of searching the screen for a sub-icon desired to be used and enhances user convenience.

Since the plurality of main icons 61-63 are arranged on an upwardly convex arc in the top menu screen 50 according to the embodiment, it is each to swipe the plurality of main icons 61-63 in a pivotal motion around the joint of the user's arm. In other words, the plurality of main icons 61-63 are arranged along a trajectory of the movement of the tip of a finger on the arc around the wrist, elbow, shoulder or the like of the user. As a result, the user can switch main icons displayed in an effortless action that does not strain the user. Since the sub-icons 71-73 for selection of respective functions are arranged around or near the main icon 62 at the center of the screen, a sub-icon can be tapped merely by changing the position of the tip of a finger slightly after swiping the finger to switch function types. Accordingly, the user can use the top menu screen 50 in an effortless operation that does not strain the user so that user convenience is enhanced.

According to the embodiment, the arrangement of the main icon 62 in a large size at the center of the screen and of the main icons 61, 63 in a smaller size to the left or right of the main icon 62 implies to the user an action of switching main icons by swiping left or right. This provides an intuitive user interface and does not require presenting additional instructions for user operation.

In further accordance with the embodiment, frequently used functions are automatically arranged in the top menu screen 50 according to the history of use by the user so that functions that are often used can be shown in the top menu screen without requiring pre-registration of favorites. This prevents an increase in items that should be registered and requirement for complicated user operations for setting associated with the expansion of functions. Since favorite functions can be arranged in the top menu screen 50 according the user setting, functions that are often used can be shown in the top menu screen 50 regardless of the frequency of use, even if the history of use is not accumulated so much.

Described above is an explanation based on exemplary embodiments. These embodiments are intended to be illustrative only and it will be understood by those skilled in the art that arbitrary combinations of embodiments and various modifications such as combinations of constituting elements and processes of the embodiments are also within the scope of the present invention.

In the exemplary embodiment described above, the main icon displayed in a large size is arranged at the center of the display area and main icons displayed in a relatively small size are arranged on the left and right of the display area. In one variation, the main icon displayed in a large size may be arranged on the left of the display area, and main icons of a small size may be arranged at the center and on the right of the display area. Conversely, the main icon displayed in a large size may be arranged on the right of the display area, and the main icons of a small size may be arranged at the center and on the right of the display area.

In the exemplary embodiment described above, sub-icons corresponding to frequently used functions or sub-icons corresponding to functions set by the user are arranged around the main icon displayed in a large size. In one variation, sub-icons indicating selected, pre-defined functions may be displayed around the main icon. For example, functions that are assumed to be frequently used when the image display device 10 is designed may be shown in the top menu screen 50 permanently.

What is claimed is:

1. An image display device comprising:
an image display means;
a user operation input means provided in a display area of the image display means; and
a display control means configured to control display by the image display means based on a user operation input in the user operation input means, wherein
the display control means is configured to:
generate a menu screen that shows a plurality of main icons indicating a plurality of function types and one or more sub-icons indicating a function belonging to one of the plurality of function types; and
display one of the plurality of main icons in the menu screen in a larger size than the other main icons, and display, around the main icon displayed in the larger size, the one or more sub-icons corresponding to some of functions belonging to the function type indicated by the main icon, an upper limit of a number of sub-icons being defined by a predetermined number.

2. The image display device according to claim 1, wherein
the display control means is configured to display the one or more sub-icons corresponding to relatively frequently used functions around the main icon displayed in the larger size.

3. The image display device according to claim 1, wherein
the display control means is configured to display the one or more sub-icons corresponding to functions pre-registered by a user around the main icon displayed in the larger size.

4. The image display device according to claim 1, wherein
the display control means is configured to display the plurality of main icons arranged on an upwardly convex arc, and switch the main icon displayed in the larger size to another main icon in response to a swipe operation along the arc provided via the user operation input means while the menu screen is being displayed.

5. The image display device according to claim 4, wherein
the display control means is configured to display the one or more sub-icons in an area at a distance from the arc on which the plurality of main icons are arranged.

6. The image display device according to claim 4, wherein
the display control means is configured to display the one or more sub-icons above the arc on which the plurality of main icons are arranged.

7. The image display device according to claim 4, wherein
the swipe operation is an operation for moving a finger left or right along the arc with the finger in contact with one of the plurality of main icons.

8. The image display device according to claim 1, wherein
the display control means is configured to display the one or more sub-icons such that an upper limit of sub-icons is determined by a predetermined number pre-registered by a user.

9. The image display device according to claim 1, wherein
the display control means is configured to arrange the main icon displayed in the larger size at a center of the display area and arranges the other main icons on the left or right of the display area.
